(19) United States
(12) Patent Application Publication
(10) Pub. No.: US 2011/0165843 A1
(43) Pub. Date: Jul. 7, 2011

(54) HANDHELD ELECTRONIC DEVICE WITH REPLACEABLE INPUT DEVICE

(75) Inventor: CHIH-YI WANG, TAIPEI HSIEN (TW)

(73) Assignee: WISTRON CORPORATION, TAIPEI HSIEN (TW)

(21) Appl. No.: 12/832,403

(22) Filed: Jul. 8, 2010

(30) Foreign Application Priority Data
Jan. 5, 2010 (TW) 099100092

(51) Int. Cl. G06F 3/02; H04B 7/005

(52) U.S. Cl. 455/41.3; 345/169

(57) ABSTRACT

The present invention relates to a handheld electronic device with a replaceable input device, which comprises a handheld electronic device, a lock-hook structure, and a wireless input device. The lock-hook structure is disposed in the handheld electronic device; the wireless input device is disposed in the handheld electronic device and hooks with the lock-hook structure. The wireless input device transmits an input signal to the handheld electronic device for inputting data to the handheld electronic device. By the wireless transmission property of the wireless input device, users can replace freely the wireless input device to be used. Thereby, the using as well as the repairing convenience of the handheld electronic device can be increased.

### FIELD OF THE INVENTION

The present invention relates generally to a handheld electronic device, and particularly to a handheld electronic device with a replaceable input device.

### BACKGROUND OF THE INVENTION

With the advancement in the electronic industry, various handheld electronic devices tend to be light and small for facilitating portability. Handheld electronic devices are electronic devices suitable for handheld operations, for example, mobile phones, multimedia players, personal digital assistants, notebook computers, handheld videogames, and handheld GPS guiders. This type of electronic devices is generally smaller in volume and lighter in weight for easier carrying.

In the trend of the lightness and smallness for handheld electronic devices, the space occupied by is more limited for the input devices, and hence the area assigned to the keys of the input devices is smaller. Thereby, the location of the keys of the input devices usually cannot comply with ergonomics. In addition, smaller input devices mean smaller keys, which implies shorter lifetime of the input device. If the input device is damaged, the user has to send it for repair, bringing inconvenience to the user.

Besides, with the progress of technologies, handheld electronic devices are not merely general electronic devices, but also a personal representation of the user. Thereby, users will choose handheld electronic devices complying with their personalities. Most of the current handheld electronic devices can only change their cases; their input devices cannot be changed. Hence, changeful users cannot change their input devices at will, reducing flexibility and fun using the handheld electronic devices.

Accordingly, the present invention provides a handheld electronic device. Users of the handheld electronic device can change the input device freely for enhancing flexibility of using as well as increasing convenience of repairing the handheld electronic device. Thereby, the problems described above can be solved.

### SUMMARY

An objective of the present invention is to provide a handheld electronic device with a replaceable input device. According to the present invention, a wireless input device is disposed in a handheld electronic device without an input device. The wireless input device transmits an input signal to the handheld electronic device for inputting data to the handheld electronic device. By the wireless transmission property of the wireless input device, users can replace freely the wireless input device to be used. Thereby, the using as well as the repairing convenience of the handheld electronic device can be increased.

Another objective of the present invention is to provide a handheld electronic device with a replaceable input device. The wireless input device is fixed by means of a lock-hook structure for avoiding the wireless input device falling off the handheld electronic device while using or carrying the handheld electronic device. Thereby, the damages caused by falling-off of the wireless input can be reduced. Besides, the lock-hook structure can also increase the convenience in assembling the wireless input device.

Still another objective of the present invention is to provide a handheld electronic device with a replaceable input device. By mutual repulsion or attraction between a push member and a push part, the wireless input device can eject from or attach to the handheld electronic device. Thereby, the convenience of assembling or disassembling the wireless input device can be enhanced.

The handheld electronic device with a replaceable input device according to the present invention comprises a handheld electronic device, a lock-hook structure, and a wireless input device. The lock-hook structure is disposed in the handheld electronic device; the wireless input device is disposed in the handheld electronic device and hooks with the lock-hook structure. The wireless input device transmits an input signal to the handheld electronic device for inputting data to the handheld electronic device. By the wireless transmission property of the wireless input device, users can replace freely the wireless input device to be used. Thereby, the using as well as the repairing convenience of the handheld electronic device can be increased.

In addition, the lock-hook structure according to the present invention is disposed in the handheld electronic structure and fixes the wireless input device for avoiding the wireless input device falling off the handheld electronic device while using or carrying the handheld electronic device. Thereby, the damages caused by falling-off of the wireless input can be reduced.

Moreover, according to the present invention, the lock-hook structure further has a push member, and the wireless input device has a push part. The push member and the push part repulse or attract each other. By mutual repulsion or attraction between the push member and the push part, the wireless input device can eject from or attach to the handheld electronic device. Thereby, the convenience of assembling or disassembling the wireless input device can be enhanced.

### BRIEF DESCRIPTION OF THE DRAWINGS

FIG. 1A shows a perspective view of a handheld electronic device with a changeable input device according to a preferred embodiment of the present invention;

FIG. 1B shows a top view of a handheld electronic device with a changeable input device according to a preferred embodiment of the present invention;

FIG. 1C shows a disassembled view of a handheld electronic device with a changeable input device according to a preferred embodiment of the present invention;

FIG. 2A shows a partial enlarged view of FIG. 1B;

FIG. 2B shows a structural schematic diagram of a hook-buckle part according to a preferred embodiment of the present invention;

FIG. 3A shows a structural schematic diagram of a lock-hook structure according to another preferred embodiment of the present invention;

FIG. 3B shows a structural schematic diagram of a wireless input device according to another preferred embodiment of the present invention;

FIG. 4A shows a motion schematic diagram of a push member according to another preferred embodiment of the present invention;

FIG. 4B shows a motion schematic diagram of a push member according to another preferred embodiment of the present invention;

FIG. 5A shows a disassembled view of a handheld electronic device with a changeable input device according to another preferred embodiment of the present invention;

FIG. 5B shows a partial enlarged view of the wireless input device in FIG. 5A;

FIG. 5C shows a partial enlarged view of the accommodating trench in FIG. 5A; and

FIG. 6 shows a motion schematic diagram of assembling the wireless input device to the handheld electronic device according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

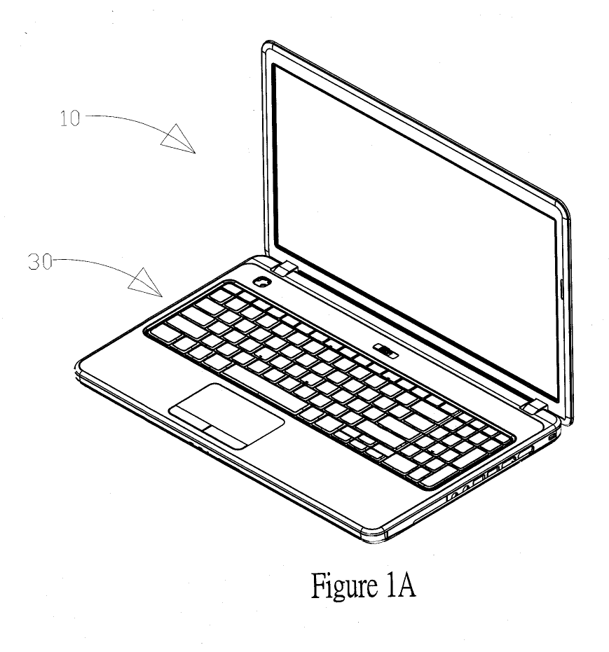

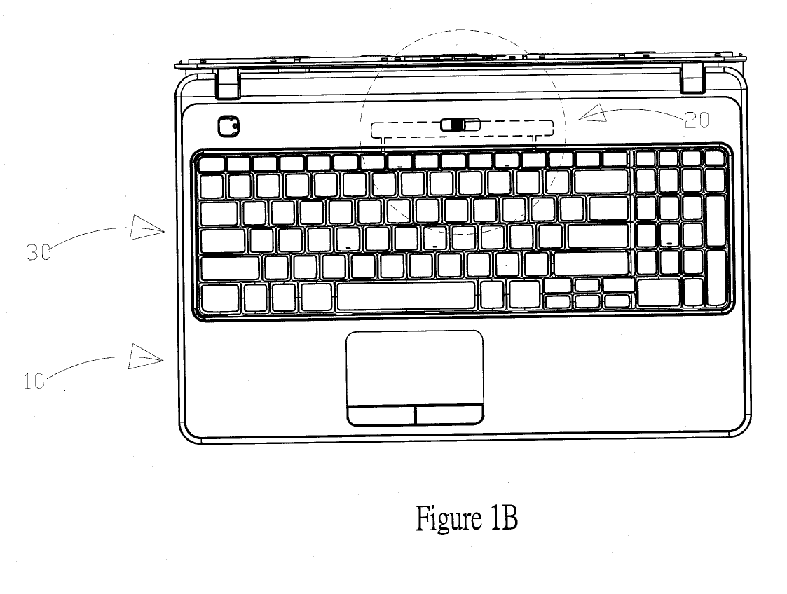

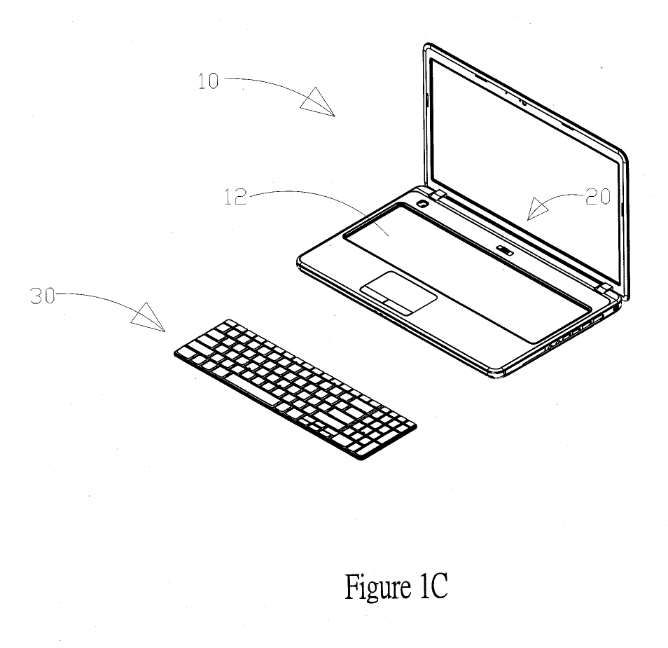

FIGS. 1A to 1C show a perspective view, a top view, and a disassembled view of a handheld electronic device with a changeable input device according to a preferred embodiment of the present invention. As shown in the figures, the handheld electronic device with a changeable input device according to the present invention comprises a handheld electronic device 10, a lock-hook structure 20, and a wireless input device 30. The lock-hook structure 20 is disposed in the handheld electronic device 10; the wireless input device 30 is disposed in the handheld electronic device 10 and hooks with the lock-hook structure 20. The wireless input device 30 transmits an input signal to the handheld electronic device 10 for inputting data to the handheld electronic device 10.

A notebook computer is used as an example of the handheld electronic device 10 according to the present invention. The handheld electronic device 10 according to the present invention does not have any input device. Namely, the handheld electronic device 10 according to the present invention does not have a keyboard module. Beside, the handheld electronic device 10 according to the present invention has an accommodating trench 12 with the wireless input device 30 disposed therein. The lock-hook structure 20 is disposed in the handheld electronic device 10 and passes through the accommodating trench 12.

The wireless input device 30 includes a keyboard and a wireless transmission module. The wireless transmission module is disposed in the keyboard, and is a Bluetooth transmission module or an infrared transmission module. In terms of the wireless transmission module, the wireless input device 30 becomes a Bluetooth wireless keyboard or an infrared wireless keyboard. By pairing between the wireless transmission module and the handheld electronic device 10, the wireless input device 30 can input data to the handheld electronic device 10. The wireless transmission module is a general technology, and will not be described here. When the wireless input device 30 is disposed in the accommodating trench 12, the wireless input device 30 hooks with the lock-hook structure 20. By means of the lock-hook structure 20, the wireless input device 30 can be disassembled or assembled freely. By the wireless transmission property of the wireless input device, users can replace freely the wireless input device to be used. Thereby, the using as well as the repairing convenience of the handheld electronic device can be increased.

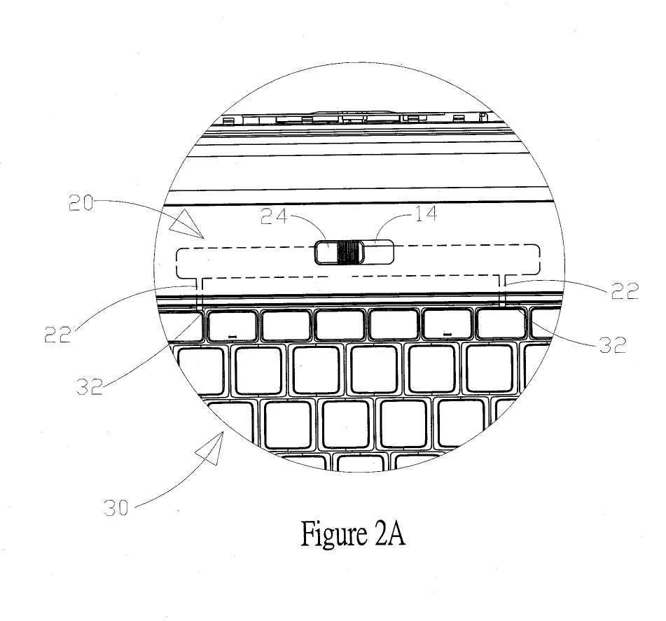

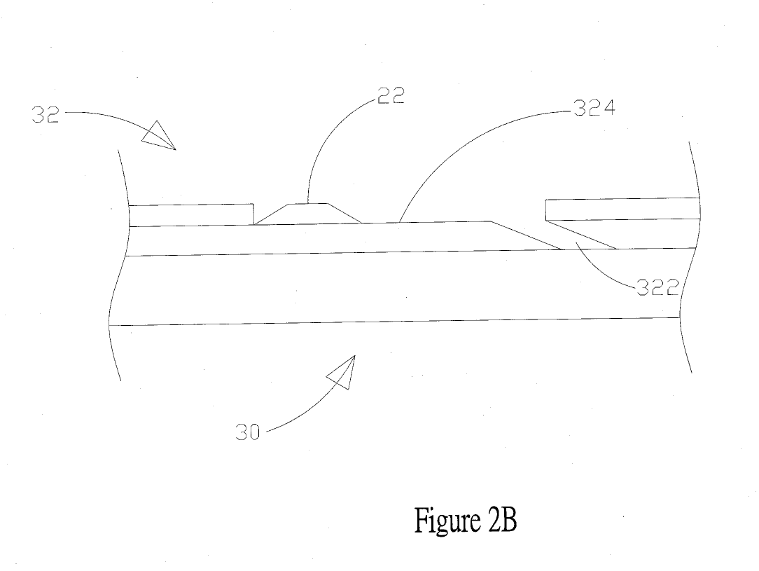

FIG. 2A shows a partial enlarged view of FIG. 1B; and FIG. 2B shows a structural schematic diagram of a hook-buckle part according to a preferred embodiment of the present invention. As shown in the figures, the lock-hook structure 20 according to the present invention has at least a lock-hook part 22; the wireless input device 30 has at least a hook-buckle part 32; and the lock-hook part 22 is disposed in the hook-buckle part 32. According to the present embodiment, two lock-hook parts 22 are used as an example. In the wireless input device 30, two corresponding hook-buckle parts 32 of the lock-hook parts 22 are disposed. To match tightly the lock-hook part 22 and the hook-buckle part 32 for avoiding falling-off of the wireless input device 30, the hook-buckle part 32 has a sloping notch 322, and the lock-hook part 22 is a sloping pillar. By matching the shapes of the sloping pillar and the sloping notch 322, the sloping pillar can be embedded in and hooked in the sloping notch 322 smoothly. Thereby, while using or carrying the handheld electronic device 10, the situation in which the wireless input device 30 falls off the handheld electronic device 10 can be prevented, and hence reducing the damages caused by the situation.

Moreover, for avoiding the wireless input device 30 withstanding the lock-hook part 22 and affecting fixing of the wireless input device 30, the hook-buckle part 32 further has a sliding groove 324 communicating with the sloping notch 322. Thereby, when the wireless input device 30 is disposed in the accommodating trench 12, the sloping pillar of the lock-hook part 22 will be in the sliding groove 324. While fixing the wireless input device 30, all the user needs to do is to push the lock-hook structure 20 so that the sloping pillar slides to the sloping notch 322 along the slide groove 324 and thus embeds in the sloping notch 322, Accordingly, the convenience of assembling the wireless input device 30 is enhanced.

Besides, for the convenience of pushing the lock-hook structure 20 by the user, a stopping part 24 is disposed on the lock-hook structure 20. The handheld electronic device 10 has a hole 14 corresponding to the stopping part 24. Thereby, the user can push the stopping part 24 to slide in the hole 14, and hence assembling or disassembling of the wireless input device 30 can be performed.

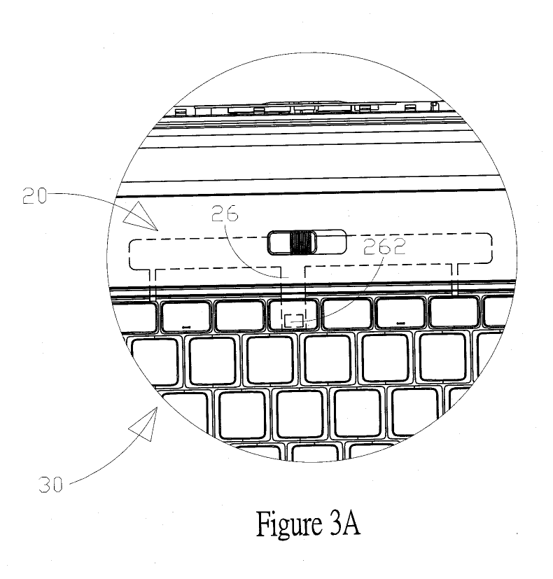

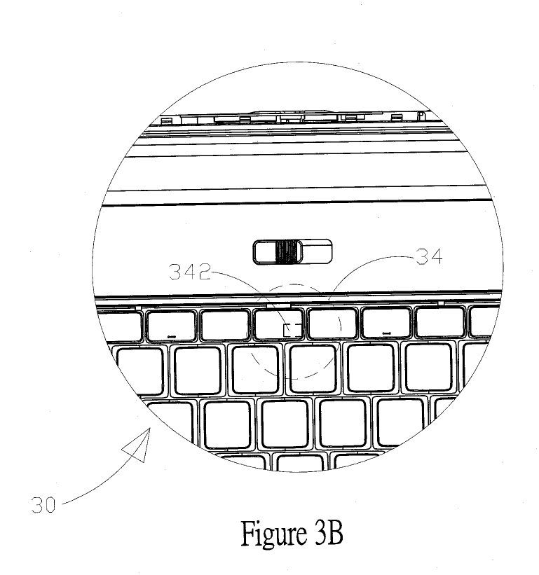

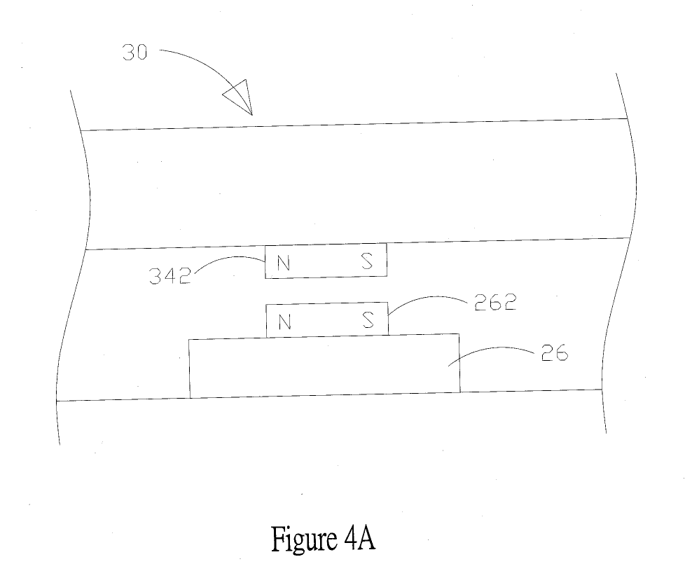

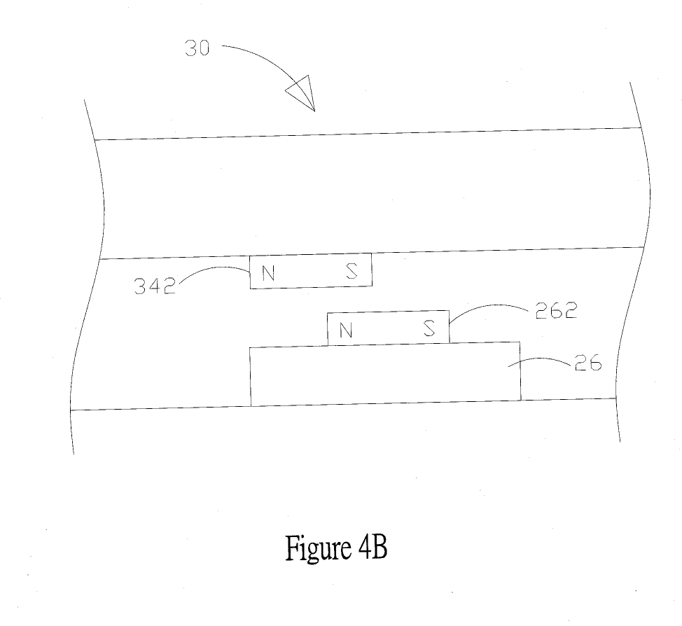

FIGS. 3A and 3B show structural schematic diagrams of a lock-hook structure and a wireless input device according to another preferred embodiment of the present invention; FIGS. 4A and 4B show motion schematic diagrams of a push member according to another preferred embodiment of the present invention. As shown in the figures, the difference between the present embodiment and the previous one is that, according to the present embodiment, the lock-hook structure 20 further has a push member 26, and the wireless input device 30 has a push part 34, wherein the push member 26 and the push part 34 repulse or attract each other. The push member 26 has a first magnetic device 262; the push part 34 is a second magnetic device 342. The locations of the first and second magnetic devices 262, 342 overlap; and the magnetic orientations of the first and second magnetic devices 262, 342 are the same.

When the user pushes the lock-hook structure 20 for disassembling the wireless input device 30, as shown in FIG. 4A, the push member 26 overlaps with the push part 34, and the first magnetic device 262 repulses the second magnetic device 342, making the second magnetic device 342 away from the first magnetic device 262, and hence making the wireless input device 30 away from the handheld electronic device 10. On the other hand, when the user pushes the lock-hook structure 20 for assembling the wireless input device 30, as shown in FIG. 4B, the push member 26 and the push part 34 are staggered, and the first magnetic device 262 attracts the second magnetic device 342, making the second magnetic device 342 close to the first magnetic device 262, and hence making the wireless input device 30 close more tightly to the handheld electronic device 10. Thereby, by mutual repulsion or attraction between the push member 26 and the push part 34, the wireless input device 30 can eject from or attach to the handheld electronic device 10. Consequently, the convenience of assembling or disassembling the wireless input device 30 can be enhanced. According to the present embodiment, the N-poles of the first and second magnetic devices 262, 342 are pointed to the left and the S-poles thereof are pointed to the right. Thereby, when the first and second magnetic devices 262, 342 overlap, the repulsion force therebetween is the greatest. On the other hand, when the first and second magnetic devices 262, 342 are staggered, the attraction force therebetween is the greatest.

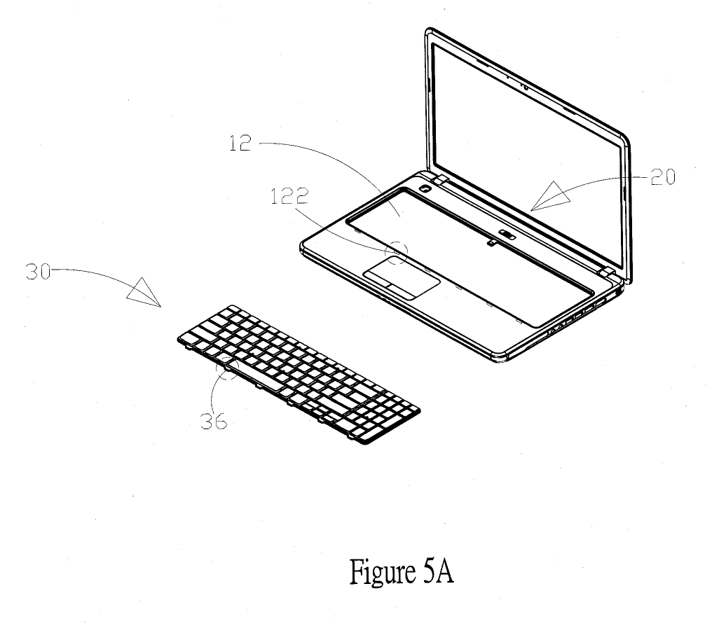

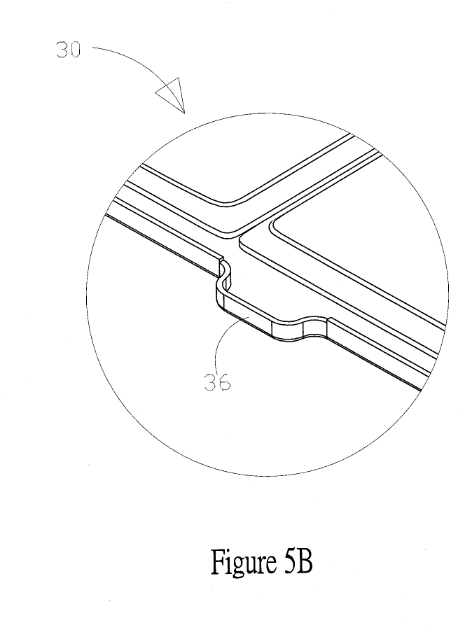

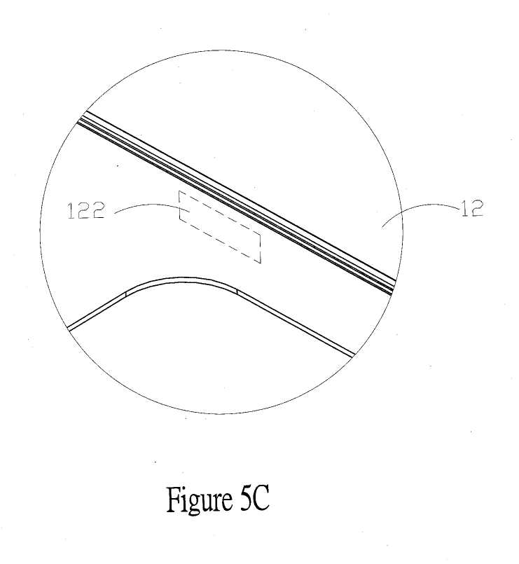

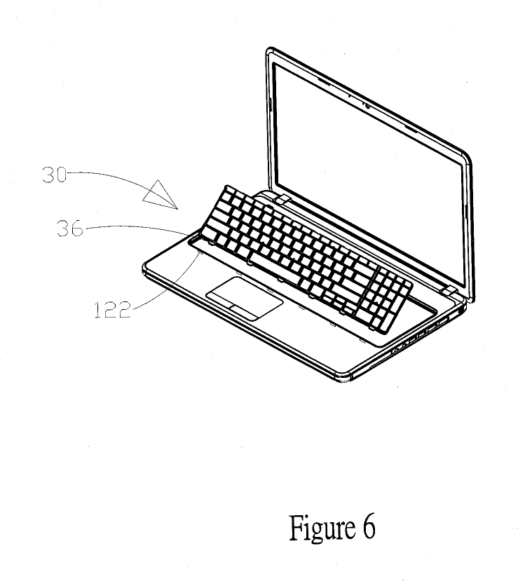

FIG. 5A shows a disassembled view of a handheld electronic device with a changeable input device according to another preferred embodiment of the present invention; FIGS. 5B and 5C show partial enlarged views of the wireless input device and the accommodating trench in FIG. 5A. As shown in the figures, for making the wireless input device disposed more tightly in the accommodating trench 12, at least an embedding member 36 is disposed on the side of the wireless input device 30. Besides, at least an embedding part 122 is disposed on the side of the accommodating trench 12 corresponding to the wireless input device 30. The embedding member 36 embeds in the embedding part 122. Thereby, when the user disposes the wireless input device 30 in the accommodating trench 12, as shown in FIG. 6, the wireless input device 30 has to be tilted at an angle. After the embedding member 36 is disposed in the embedding part 122, the wireless input device 30 is pushed downwards. Then the lock-hook structure 20 is pushed for fixing the wireless input device 30.

To sum up, the handheld electronic device with a replaceable input device according to the present invention comprises a handheld electronic device, a lock-hook structure, and a wireless input device. The lock-hook structure is disposed in the handheld electronic device; the wireless input device is disposed in the handheld electronic device and hooks with the lock-hook structure. By the wireless transmission property of the wireless input device, users can replace freely the wireless input device to be used. Thereby, the using as well as the repairing convenience of the handheld electronic device can be increased.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A handheld electronic device with a replaceable input device, comprising:
a handheld electronic device;
a lock-hook structure, disposed in said handheld electronic device; and
a wireless input device, disposed in said handheld electronic device and hooking said lock-hook structure, said wireless input device transmitting an input signal to said handheld electronic device for inputting data to said handheld electronic device.

2. The handheld electronic device with a replaceable input device of claim 1, wherein said handheld electronic device has an accommodating trench; said wireless input device is disposed in said accommodating trench; and said lock-hook structure passes through said accommodating trench.

3. The handheld electronic device with a replaceable input device of claim 2, wherein said wireless input device has at least an embedding member; said accommodating trench has at least an embedding part; and said embedding member is disposed in said embedding part.

4. The handheld electronic device with a replaceable input device of claim 1, wherein said lock-hook structure has at least a lock-hook part; said wireless input device has at least a hook-buckle part; and said lock-hook part is disposed in said hook-buckle part.

5. The handheld electronic device with a replaceable input device of claim 4, wherein said hook-buckle part has a sloping notch; said lock-hook part has a sloping pillar; and said sloping pillar is disposed in said sloping notch.

6. The handheld electronic device with a replaceable input device of claim 5, wherein said hook-buckle part has a sliding groove communicating with said sloping notch; and said sloping pillar slides along said sliding groove and embeds in said sloping notch.

7. The handheld electronic device with a replaceable input device of claim 1, wherein said lock-hook structure further has a push member; said wireless input device has a push part; and said push member and said push part repulse or attract each other.

8. The handheld electronic device with a replaceable input device of claim 1, wherein said push member has a first magnetic device; said push part is a second magnetic device; and said first magnetic device and said second magnetic device overlap.

9. The handheld electronic device with a replaceable input device of claim 8, wherein the magnetic orientations of said first magnetic device and said second magnetic device are the same.

10. The handheld electronic device with a replaceable input device of claim 1, wherein said lock-hook structure has a stopping part disposed on said lock-hook structure.

11. The handheld electronic device with a replaceable input device of claim 1, wherein said wireless input device includes:
a keyboard; and
a wireless transmission module, disposed in said keyboard.

12. The handheld electronic device with a replaceable input device of claim 11, wherein said wireless transmission module is a Bluetooth transmission module.

13. The handheld electronic device with a replaceable input device of claim 11, wherein said wireless transmission module is an infrared transmission module.

14. The handheld electronic device with a replaceable input device of claim 1, wherein said handheld electronic device does not have any keyboard module.

15. The handheld electronic device with a replaceable input device of claim 1, wherein said handheld electronic device is a notebook computer.
